(19) United States
(12) Patent Application Publication
(10) Pub. No.: US 2006/0064305 A1
(43) Pub. Date: Mar. 23, 2006

(54) Security and property management system

(76) Inventor: Jose M Alonso, Alpharetta, GA (US)

Correspondence Address: LAURENCE P. COLTON, 1201 WEST PEACHTREE STREET, NW, 14TH FLOOR, ATLANTA, GA, 30309-3488, US

(21) Appl. No.: 10/526,319

(22) PCT Filed: Apr. 30, 2003
(86) PCT No.: PCT/US03/13434

§ 371 Date: Feb. 25, 2005

Related U.S. Application Data
(60) Provisional application No. 60/377,013, filed on Apr. 30, 2002.

(51) Int. Cl. G06Q 99/00

(52) U.S. Cl. 705/1

(57) ABSTRACT

A comprehensive real property management system having an interactive system for reporting, tracking, and rectifying security and maintenance incidences and for generating alerts and reports for a building, for an office complex comprising a number of buildings, and/or for a real property management company having multiple buildings and multiple sites.

### STATEMENT OF RELATED APPLICATIONS

This patent application is based on and claims priority on U.S. Provisional Patent Application No. 60/377,013 having a filing date of 30 Apr. 2003, currently pending.

### BACKGROUND OF THE INVENTION

1. Technical Field

The present inventions generally relates to the field of automated security and property management systems and more specifically relates to the field of centralized automated and computerized security and property management systems typically for larger sites, such as office buildings and the like, for handling security and maintenance items, and other property management topics, the systems comprising security guard tracking, maintenance and preventive maintenance, and monitoring and tracking security and maintenance events from the initial incident through final resolution.

2. Prior Art

In general, current property security systems range from simple key locks and watchdogs to elaborate systems comprising cameras, microphones, sirens and people, and computers to link them all together. For many office buildings or complexes, guards patrol the building or complex in a set circuit, checking in as they go, or entering information into a portable computer or similar device to indicate their travels. Incidents, such as break-ins, unlocked doors and maintenance requests are logged in to a central database, and the appropriate action is undertaken by the security or management company.

Similarly, current property management systems for maintenance range from simple reports made from the nightly cleaning staff to elaborate systems comprising internet or intranet reporting tools through which building managers or tenants can report maintenance worries. For many office buildings or complexes, the tenant is responsible for reporting any maintenance concerns, after which the building management then will attempt to rectify the concern. Often, the reporting system only comprises a database of the concern, and whether the concern was addressed.

Many security companies and systems lack sufficient security officer training in both daily and emergency procedures. Due to such a lack of training, security officers in groups of buildings often fail to cross-communicate in emergency situations, both natural and criminal. Similarly, verification systems currently provide reports that often require manual filtering in search of problems and expectations. Such verification systems are not self-reporting and require the user to do the filtering and produce usable reports. Manual production of reports is less cost-efficient than automatic production of reports.

Current security, maintenance, and property management systems generally are reactive and not proactive and generally are separate for security and maintenance services. Thus, there is a need for a proactive security and property management system that is capable of tracking and handling both security and maintenance services, as well as other services typically needed by an office building or complex. There also is a need for a security and property management system that allows the input and tracking of incidences from discovery through rectification to follow-up to insure the incidences have been rectified to either or both the property management's or the tenant's satisfaction. There is a further need for a security and property management system that provides an up-to-the-minute status report for each incidence, its importance, who or what is or should be handing the incidence, and a graphic representation of these important criteria for one or more building or sites that may comprise an office complex. It is to these needs and other related needs that the present invention is directed.

### BRIEF SUMMARY OF THE INVENTION

The present invention is a comprehensive security and property management system addressing the previously discussed needs comprising an interactive system for reporting, tracking, and rectifying security and maintenance incidences in a building, in an office complex comprising a number of buildings, and/or for a property management company having multiple buildings and multiple sites. In addition to the security and maintenance features, other optional features can be added to the system to customize the system for different needs and/or to make the system a more complete solution for a property management company.

Briefly, the present system comprises a centralized computing and database server with which various peripheral components interface. The various peripherals can comprise a network operations center through which all actions are routed and processed; an internet/intranet connection allowing remote operation and access by the property management company, the local building management, and the tenants; interfaces devices such as palm computers, laptop computers, barcode scanners, and other input/output devices for use by security guards, maintenance workers, and property management; delivery systems such as fax machines, email appliances, and pagers through which reports can be delivered and users can be contacted; and a back-up system.

General access to the present system comprises an input/output interface through which information is entered into and obtained from the system. An illustrative interface can comprise a screen divided into several sections, with each section comprising information about a discrete property, service or other data of interest. For example, one screen can have a section devoted to a list of properties or buildings and another section giving a summary of all items and incidences. The user or operator of the system then is able to investigate each property, view the status of any incidences, determine any incidences that need to be addressed, review incidences from the previous day or other time period, assign a level of priority to each incidence, and contact the appropriate party to address the incidence.

### BRIEF DESCRIPTION OF THE DRAWINGS

FIG. 1 represents an overall general schematic of the system of the present invention, including representative hardware and a flow pattern for the steps, cooperation and communication between and among components of and persons involved in the present invention.

FIG. 2 illustrates a security officer summary page prepared by the present invention.

FIG. 3 illustrates a manager summary page prepared by the present invention.

FIG. 4 illustrates a create incident page for the present invention.

FIG. 5 illustrates a schedule page for the present invention.

FIG. 6 illustrates a schedule item page for the present invention.

FIG. 7 illustrates a schedule tour list page for the present invention.

FIG. 8 illustrates a preferences page for the present invention.

FIG. 9 illustrates a user setup page for the present invention.

FIG. 10 illustrates a category set up page for the present invention.

FIG. 11 illustrates a building set up page for the present invention.

FIG. 12 illustrates a location set up page for the present invention.

FIG. 13 illustrates a post set up page for the present invention.

FIG. 14 illustrates a group set up page for the present invention.

FIG. 15 illustrates a mail alias set up page for the present invention.

FIG. 16 illustrates a user report generation page for the present invention.

FIG. 17 illustrates a summary report generation page for the present invention.

FIG. 18 illustrates a schedule reports generation page for the present invention.

FIG. 19 illustrates a sample report generated for the present invention.

FIG. 20 illustrates a log in page for the present invention.

FIG. 21 illustrates a log out message for the present invention.

FIG. 22 illustrates an enter post page for the present invention.

### DETAILED DESCRIPTION OF THE PREFERRED EMBODIMENTS

The present invention is a comprehensive security and property management system comprising an interactive system for reporting, tracking, and rectifying security and maintenance incidences in a building, in an office complex comprising a number of buildings, and/or for a property management company having multiple buildings and multiple sites. The design of this invention combines functionality with a graphic user interface. Current ASP's are limited by text field boxes and conventional table cells. The present invention provides a suitable solution with equivalent functionality and finite control over the product look, feel and user workflow, and uses technology such as Macromedia Flash® or the equivalent. For example, currently existing products are hampered by internet bandwidth and hyper-text markup language (HTML) limitations in tandem with browser limitations (i.e., Internet Explorer® and Netscape Navigator®). Current product designs typically use HTML rather than Flash® because of its past inability to front a complex database system. Flash® typically has been an artist's tool rather than a programmer's tool and because the two expertises typically do not cross, Flash® is not used extensively in product design. Flash® now supports encrypted XML communications to a server. XML is becoming the standard for internet database communications. New changes in the scripting language allow for complete customization of the look. These factors in combination make Flash® a viable product design alternative.

The use of a Flash® type of technology means that the user workflow and product look will be significantly advanced beyond competing products, giving the present invention a huge differentiating factor and selling point. For example, users will be able to place a cursor on the form and directly type in information, rather than having to pull up a separate entry screen with text boxes (that is, a separate window or drop-down box). Interface controls can be more interactive and visual (Help, for example, can have bubbles with arrows that appear to physically point at which areas to fill in next).

1. Functional Specifications of the System

Following is an outline of major functional specifications for the system:

a. Design of the Database. The database system preferably is able to handle large amounts of requests (such as incidence reports, maintenance requests, etcetera) and be able to grow. There is a lot of data that is being generated by the users and clients so it is necessary to set up the data to traverse it quickly. Also, most of the data in the system is dated and will need to be pruned.

b. Security. All data should be secure, stable and in tact.

c. Control Center. A control center system monitors the state of the system and clients, and checks integrity. Using a dual-head system, the Network Operations Center (NOC) operator can easily see the highest priority items for each client.

d. Accounts. Each account has a large amount of functionality that needs to be implemented. This includes maintaining a security guard list and access, building administration access, building maintenance tasks, scheduling the number of security guards, schedules for each station, status reports, operations instructions, building checklists and daily and weekly notices.

e. Access. There can be a tiered access scheme. Users can set up administrators for each building and add security guards for each building. The administrators can have the ability to change any data in the system and NOC operators can have a subset of that system.

f. Login system. Secure login for each security guard station and administration. Logins can be limited to specific IP addresses and time range.

g. Security Guard Station. Security guards can have the ability to view their current schedule of events, create reports including building reports, view any recent notices, send and receive internal email within our system.

h. E-mail system. There can be an internal email system between all levels of employees.

i. Email/Fax system. Client reports can be generated and sent via email or faxed.

j. Reports. In addition to alerts there are a large number of other reports that also can be made available behind the scenes on the administrative side. Since this product is becoming the paper replacement system for security guards, the reporting system will generate all of the other reports.

2. System Installation

The design of the system is to build a foundation that can easily grow as the business grows. The amount of Internet traffic will not be limited by the computer infrastructure at the NOC. The initial installation can be done with a minimum of computer systems. Here is a list of functionality of each representative computer:

a. Database Server. This machine's function is to maintain the database that contains all of the client data. It can have a RAID file system to minimize failures. This system can and should have very limited access.

b. Internet server. This machine handles all of the Internet requests. Any database access can be done over an internal network to the database server. Having a separate Internet server from the database server allows more efficient growth as client demands grow. Since all of the data that is sent over the network preferably is encrypted, this is an additional computation expense that may need to be distributed over a number of Internet servers.

c. Control center. This is the monitoring system by the NOC operators.

d. Mail/Fax server. This machine handles all requests to contact the clients via email, fax and pagers.

There can be a high-speed network between all of the machines to minimize latency. There also can be a backup solution to back up the client data nightly or on some other set or selected period of time.

3. First Illustrative Example with Reference to the Figures.

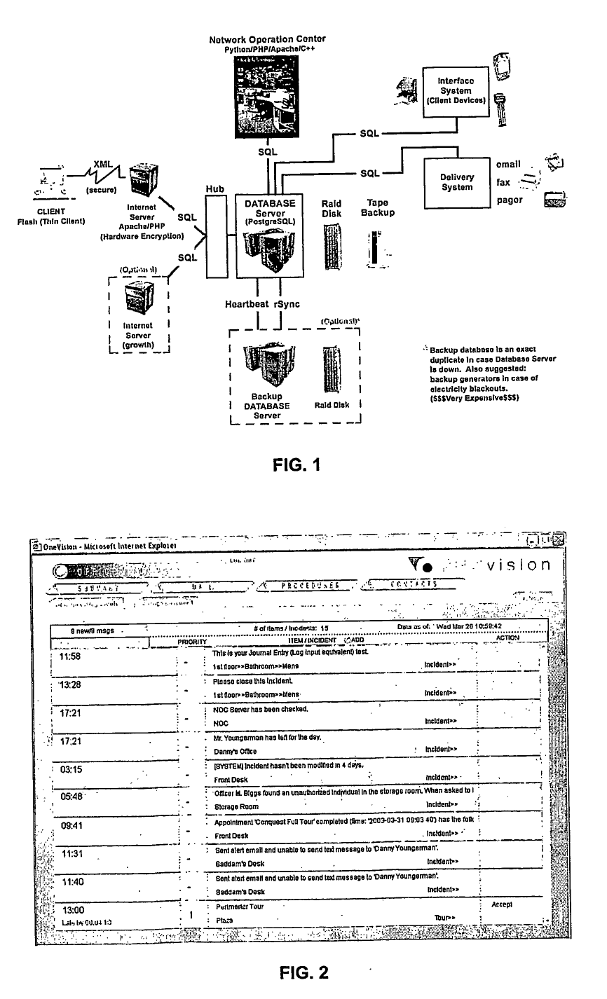

FIG. 1 represents an overall general schematic of the system of the present invention, including representative hardware and a flow pattern for the steps, cooperation and communication between and among components of and persons involved in the present invention. The database server preferably stores all of the data for the system, including information about the various users, clients, properties, buildings, security systems and companies, maintenance companies, and any other data necessary or desired to operate the system. The Network Operation Center provides a means for monitoring the state of the system and clients, and to check the integrity of the system.

An Internet server allows direct user and client access to the system. This allows the users, such as the property or building management team, the property or building owner, and/or the tenants to access the system and to check on the status of the properties and/or buildings and any pending incidence reports. The interface systems allow input to and output from the system from security guards, maintenance workers, cleaning crews and the like, so as to inform the system of any incidences and whether the incidences have been addressed. A delivery system allows reports to be delivered to appropriate parties through a number of different media.

One or more backup systems are shown. At a minimum, it is preferable to have a backup system for the data. More preferably, there can be a backup for the entire database server so as to have a double redundancy in the system.

FIG. 2 illustrates a security officer summary page prepared by the present invention. The officer summary page can have links to the item/incident page, electronic mail for the officer, emergency and daily procedures, and contacts. Initially, the user enters various items and incidents (third column) for the security officer to complete, including for example target completion times (first column) and priorities (second column). As the security officer completes each task, the security officer records the completion. The present invention then automatically updates the system database and the summary page to record the actual time of completion. If the security officer does not complete a task by the target completion time, the present invention can highlight the uncompleted task and/or indicate that the completion of the task is late, as well as indicating how late the task was completed, if completed. Further, tours can be automatically downloaded to the security officer summary page and/or the security officer's handheld device when the security officer accepts the task (fourth column).

A similar page can be prepared for maintenance items and for use by maintenance personnel. Such a page would allow for the entry of and list various maintenance items and incidents for the maintenance personnel to complete, including for example target completion times and priorities. As the maintenance personnel complete each task, the maintenance personnel records the completion. The present invention then automatically updates the system database and the summary page to record the actual time of completion. If the maintenance personnel do not complete a task by the target completion time, the present invention can highlight the uncompleted task and/or indicate that the completion of the task is late, as well as indicating how late the task was completed, if completed. Further, maintenance schedules can be automatically downloaded to the maintenance personnel summary page and/or the maintenance personnel's handheld devices when the maintenance personnel accept the task.

Security officers, maintenance personnel, and other users of the present invention can carry handheld devices such as personal digital assistants or other palm sized computing devices programmed for the present invention. Such handheld devices allow the security officer and maintenance personnel to review items, incidences, tours, and tasks, as well as any other information provided through the present invention. For example, the handheld devices can comprise a touch screen, a keypad inputs, and/or a barcode reader as input devices. Preferably, the handheld device can show the tour duty list generated for each individual security officer or maintenance person. The security officer and maintenance personnel can check off each item completed, thus updating the system database. Warning boxes can pop up on the handheld screen to show items missed during a tour and/or new items for completion.

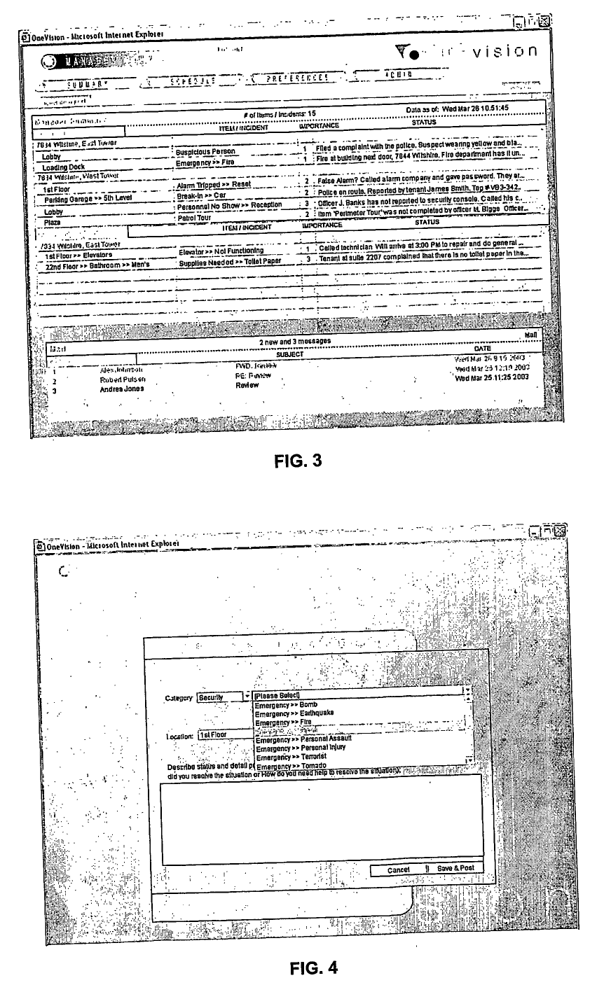

FIG. 3 illustrates a manager summary page prepared by the present invention. The manager summary page can have links to the summary page, a schedule page, an administrative page, and/or user preferences, as desired. On the manager summary page, the various building locations are shown (first column), along with an item/incident list (second column), importance (third column) and status (fourth column) for each location. Exceptions can automatically appear on the manager summary page, such as the tour not completed by the security officer shown on the 7834 Wilshire, West Tower Plaza line of FIG. 3. Likewise, the various activities can be shown, such as, for example, security tasks, maintenance tasks, and electronic mail.

FIG. 4 illustrates a create incident page through which the various status reports can be entered into the system database. Generally the security officers, maintenance personnel, and other appropriate persons enter this information by using this type of incident report interface. The user can select the category of incident, such as for example security or maintenance, and select any of the preprogrammed types of incidents, such as earthquakes or burst pipes. The user also can select the physical location of the incident and type in the details of the incident in free form text. The system database is updated and the incident information appears on the manager summary page of FIG. 3. The manager then can review the incident, contact the security officer, maintenance personnel or other person for additional details, amend the free form text, and make comments as desired.

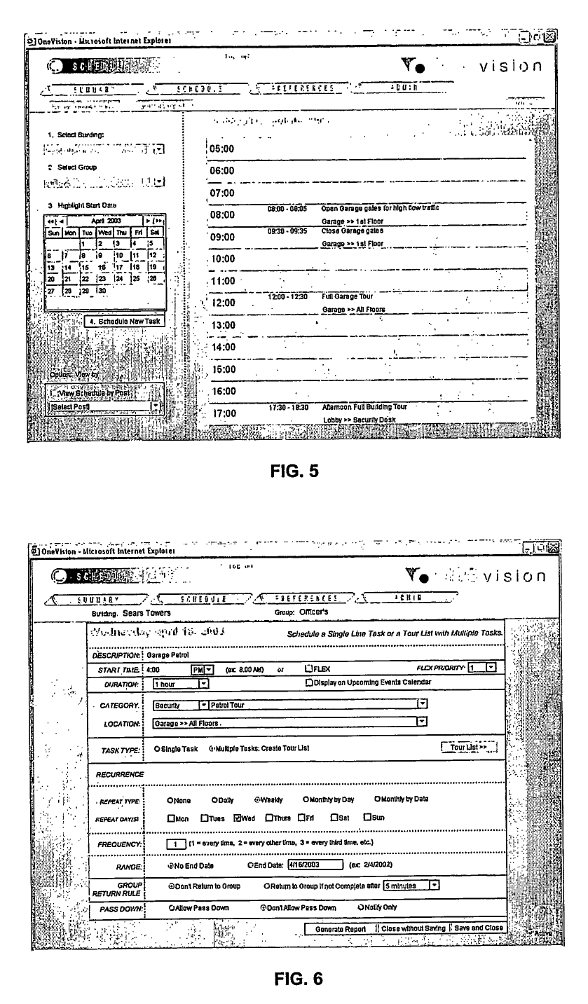

FIG. 5 illustrates a schedule page for reviewing tour schedules and information. This page can include a monthly, daily and/or hourly calendar, a view of scheduled tasks, and a method for entering tasks. For entering tasks, the user can select the building location, the group to whom the task is assigned, the date of the task, and the post.

FIG. 6 illustrates a schedule item page for entering the details of a task. The information that can be entered can include, for example, a description of the task, the start time and duration, the category and location, and the task type and frequency. For recurring tasks, additional information can be entered such as, for example, the repeat type, frequency, and date range. The system database automatically is updated upon the entry of a task.

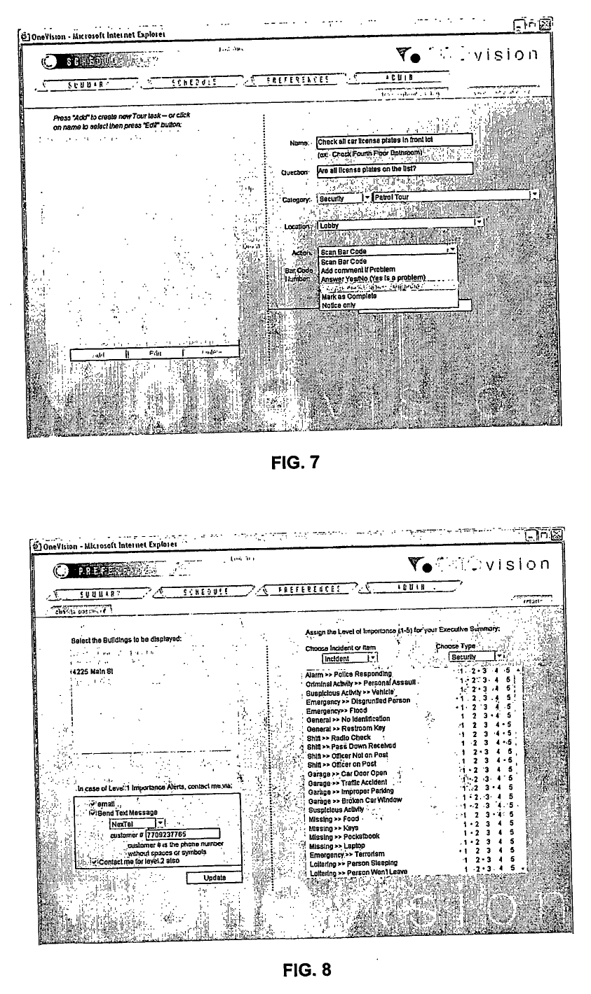

FIG. 7 illustrates a schedule tour list page for creating tours. In this illustrative page, the various task previously entered through the pages shown in FIGS. 5 and 6 can be viewed on the right side of the page. Alternatively, new and/or alternative tasks can be created using the drop down boxes on the right side of the page. Desired tasks are selected and added to the tour list on the left side of the page, where the tasks can be ordered and reordered as desired. In this manner, customized tours can be created for the security officers and other users of the present invention.

FIG. 8 illustrates a preferences page for creating summary reports for use by management and others. The left side of the page shows the various buildings and other properties that can be included in the reports and methods of contact or notification. The user can highlight the buildings and other properties as desired, and the method the user wishes to be notified if an incident or item arises, is completed, or fails to be completed. The right side of the page shows the various incidents or items that can be included in the report, along with relative importance (from 1 to 5) that the user deems appropriate to include in the report and that might require one to take action.

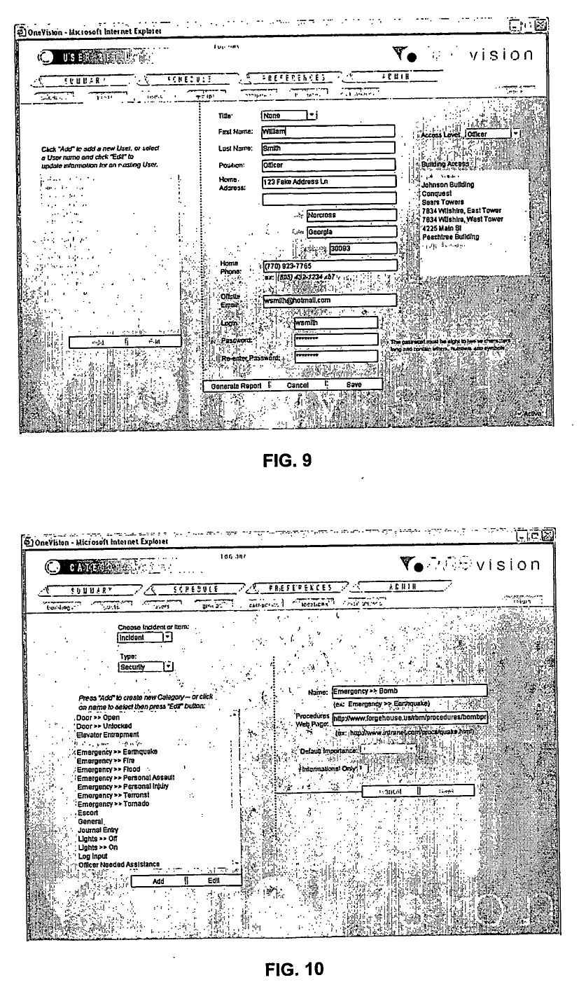

FIG. 9 illustrates a user setup page for, in this illustrative example, entering information about a specific user of the system of the present invention. This page allows the entry of pertinent information about each user, including personal information and building access information.

A desired feature of the present invention is its ability to alert users, managers, and/or other desired persons about incidents and items. For example, certain users or managers may need to be informed immediately if an incident occurs. Maintenance people may need to be informed if a pipe bursts and security people may need to be informed if there is a break in. The present invention provides a capability for providing and receiving real time alerts via e-mail, mobile telephone text messaging, desktop computer pop up displays, instant messaging, and/or upon logging into the system. Specifically, if an incident or item occurs that is on a particular manager's or executive's alert list, an alert can be sent to the manager or executive via any or all of the listed methods.

Further, the present invention has many built in and included features for increasing the overall efficiency of property management. These features can include customized reporting capabilities with real time reports; detailed daily, weekly, and monthly reports by category or incident; tracking the accountability of contractors, security personnel, parking attendants, janitorial staff, maintenance staff, and engineers; training of entry level personnel and relief personnel; and an easy to use interface. Additionally, these features can include a highly customizable interface that adapts to the user's needs; an event driven date and time stamp per task completed; automatic exception notifications via e-mail, text messaging and other methods; direct communication to end users with less chance of miscommunication; and secure 128-bit encryption.

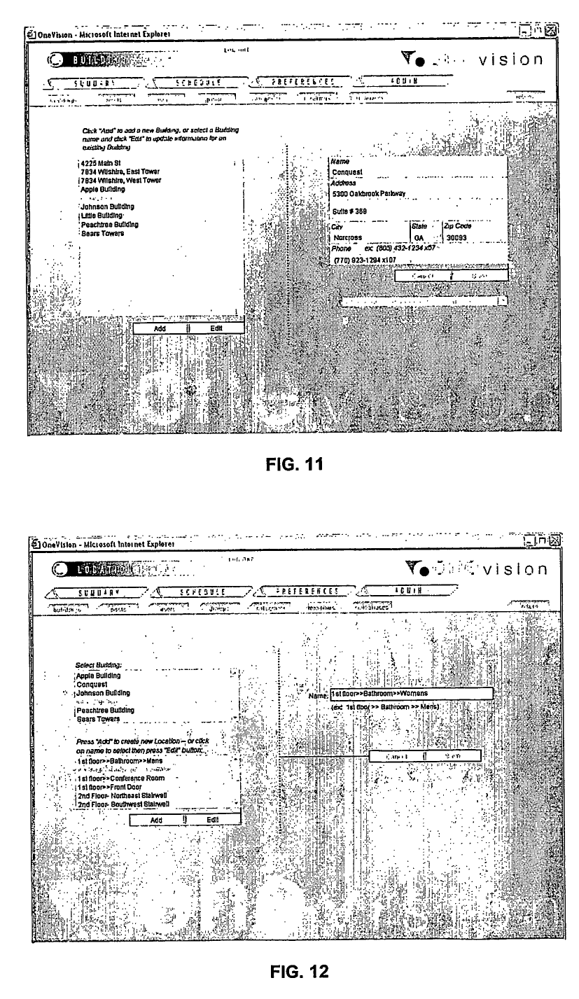

FIGS. 10 through 15 illustrate specific set up pages for the present invention. These pages can be used to input initial information, or to change or update information, regarding specific features. FIG. 10 illustrates a category set up page through which incidents and items can be entered. As an illustrative example, whether the entry is an incident or item, the type such as security or maintenance, the category name, a link to procedures to follow in the event the item or incident arises, and importance can be entered. FIG. 11 illustrates a building set up page through which buildings and other properties can be entered. As an illustrative example, the Conquest location is being added with its address and telephone numbers. FIG. 12 illustrates a location set up page through which various locations of interest or importance within previously entered buildings can be defined. As an illustrative example, the first floor women's bathroom in the Little building is being added as a new location. These buildings and locations then can be added to tours.

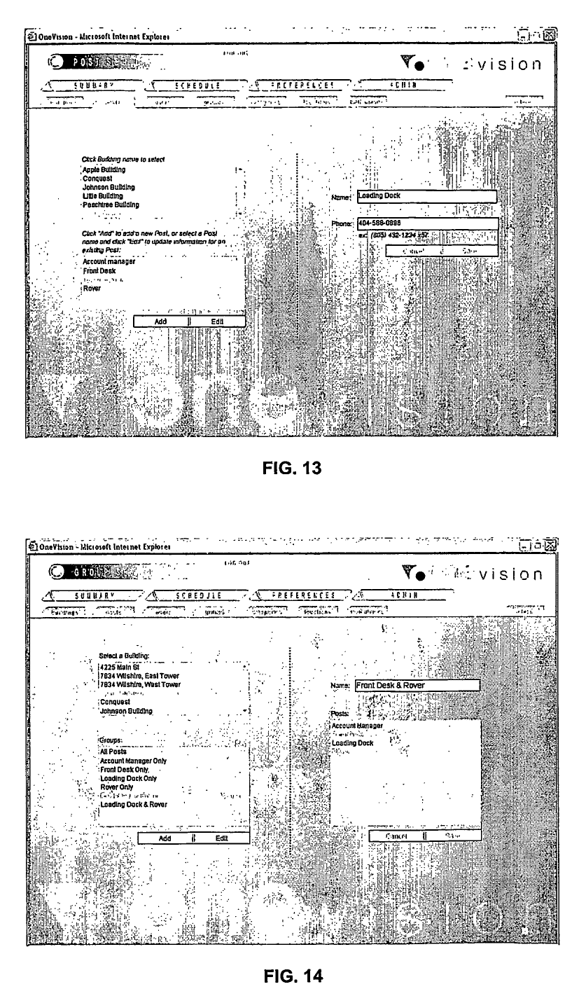

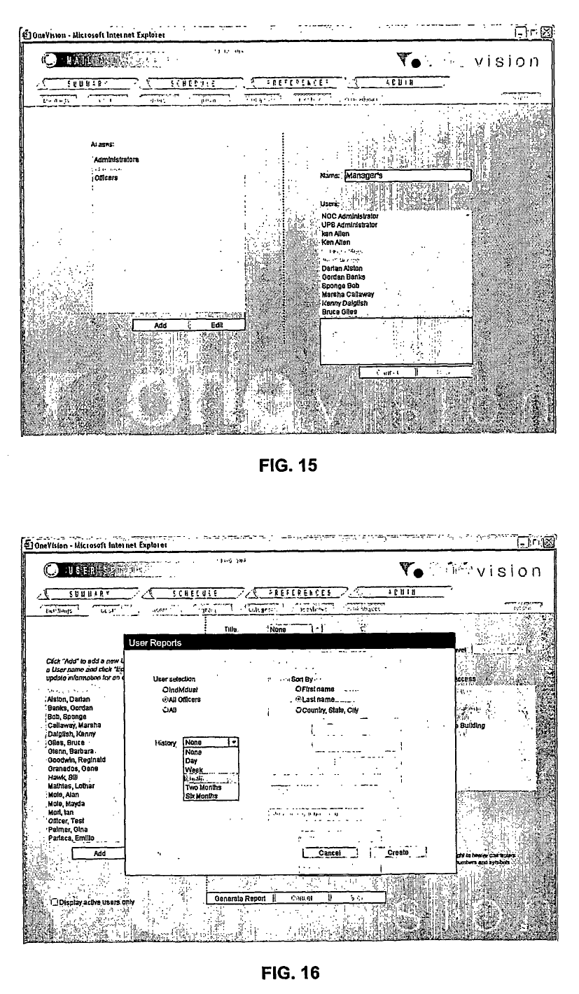

FIG. 13 illustrates a post set up page through which various posts can be set up. A post can be a guard location, a manager's location, a roving security officer, a janitor's room, or the like. As an illustrative example, the loading dock at the Sears Towers is being added as a new post. FIG. 14 illustrates a group set up page through which one or more posts can be combined into a group. A group can be used when a task or other feature is to be assigned to more than one post. As an illustrative example, the front desk and rover posts of the Apple Building are being combined into a group. FIG. 15 illustrates a mail alias set up page through which users can be grouped into mail alias categories for receiving batch e-mails or other alerts.

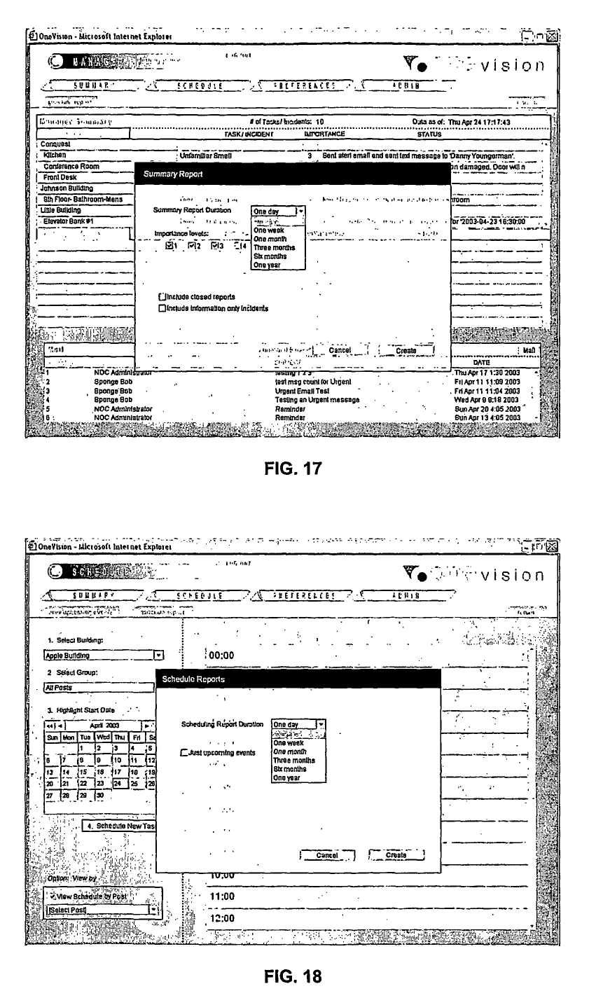

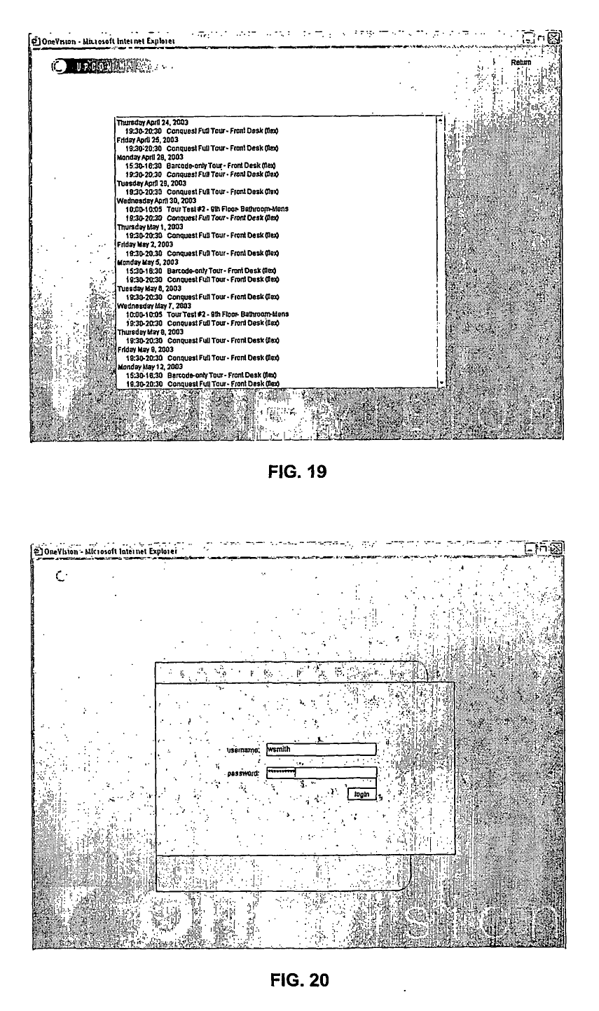

FIGS. 16 through 19 illustrate specific report generation pages for the present invention. FIG. 16 illustrates a user report generation page through which various reports about the users can be generated. As an illustrative example, a report is being generated for all security officers listed in the past month sorted by last name. FIG. 17 illustrates a summary report generation page through which various reports about tasks and incidents can be generated. As an illustrative example, a report is being generated for all incidents for the current day having importance levels 1, 2, and 3. FIG. 18 illustrates a schedule reports generation page through which various reports about scheduled tasks can be generated. As an illustrative example, a report is being generated for all scheduled tasks for the current day. FIG. 19 illustrates a report generated for upcoming events in chronological order.

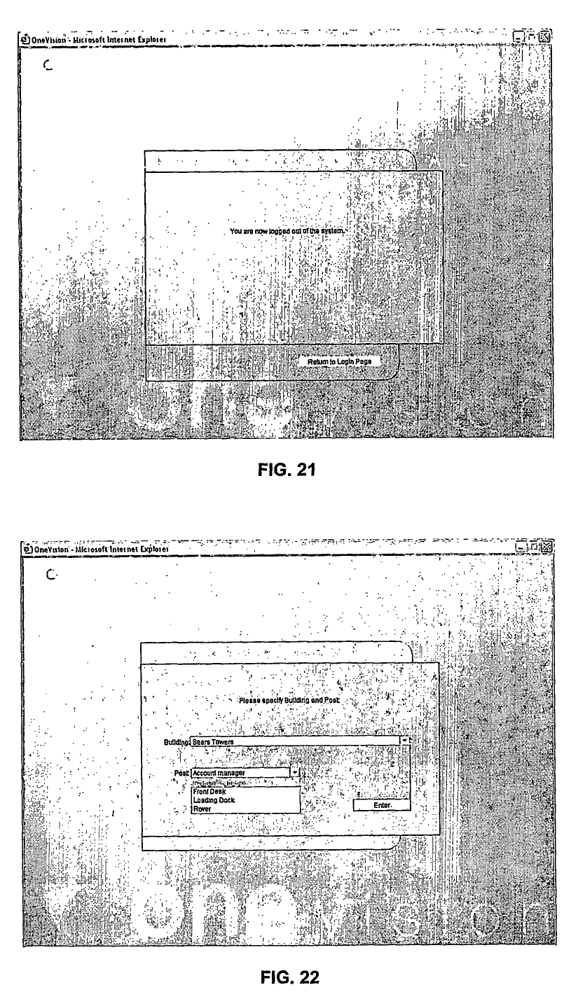

FIGS. 20 through 22 illustrate specific log in and log out pages. FIG. 20 illustrates a log in page for the entire system. FIG. 21 illustrates a log out message for the entire system. FIG. 22 illustrates an enter post page for reviewing and acting on a specific post. As an illustrative example, the user is entering the Sears Towers account manager post.

The present invention allows the scheduling of tasks and assignments by groups. This enables the manager or administrator to assign a task to any individual post while also giving the flexibility to assign to a group of posts (for example, Entire Building, which in this case would consist both the Front Desk and Loading Dock Posts). Users log in to a post, and groups consist of one or more posts. Users only belong to a post by virtue of the fact that they log in to that post and follow the schedule given to that post. In fact, a user may log in to any post that belongs to the buildings to which they are allowed access. The present invention is designed this way so that, for example, security officers may cover the schedules of any post in the event of a no show, exchange posts for variety, etcetera.

After a tour has been scheduled, managers have the ability to change the way a tour is performed. Further, managers have the ability to schedule the same tour, done in different ways, in different days.

The present invention provides a framework for communications. Utilizing the XML standards for communications, any user or client can communicate with the system database and functionality. The database is designed with reuse in mind and there are methods in place to allow database mining and querying. There is a messaging trigger system in place to allow asynchronous communications to occur without constant polling. This allows users and clients to be told when an event has occurred rather than having to ask.

Security of both the database and the server is importance. There are inheriting standards in place so neither the database nor the server can be compromised. All requests are reviewed for permissions and validity and all communications must be secure. All communication is done using a protocol such as socket port 443, which is the secured HTML protocol port. The content management and delivery system is selected with security and reliability in mind. By using open standards, much of the hardware and software decisions can be made by the client to better integrate into their current technology strategy. Using the World Wide Web as the method of communications provides a much greater client base and expandability then limiting the system to a particular install base. The client was developed to execute on almost any platform in existence. It can run on Windows®, Linux®, Apple®, Solaris®, and many other flavors of UNIX.

Additional optional features include a preventive maintenance module, a maintenance budgeting tool, and an alert mechanism for critical emergencies for non-users. The preventative maintenance module works very similarly to the scheduling module disclosed above but only for maintenance-related items (for example, schedule air filter change every three months). The maintenance budgeting tool keeps track of supplies-related expenses and inventory, as well as money left in the budget. The alert mechanism for critical emergencies is for non-users, such as building tenants, and allows property tenants to enter complains about janitorial and maintenance problems, tasks which will be automatically assigned to the maintenance vendor via two-way pager. The maintenance vendor will be able to accept the task via pager, and complete it. Meanwhile the building manager can view all the messages from the tenants.

4. Operation of the Invention.

The present invention is a computer-based system for managing real properties, including, for example, the security and maintenance aspects of buildings and grounds. By using the system, property owners and managers, and their employees, can have the ability to manage single properties, multiple properties and groups of properties with more efficiency and less relative cost while receiving more and more timely information regarding the status of the property.

The following discussion of the system of the present invention refers generally to the first illustrative example above and the appended FIGs., and also generally to the second illustrative example below. Although this discussion is based primarily on the management of a single building, this is for ease of explanation, and is not meant to be limiting in any aspect, as the present invention can be used to manage more than one building or other property simultaneously. Further, property management generally comprises a building, an owner, management, security, maintenance, and janitorial. This discussion is based primarily on security and secondarily on maintenance; however, both security and maintenance, as well as other aspects of building and property management can be managed by this invention.

Once the user (whether the building owner or management company, for example) begins to use the system, various screens are available on the user's computer. Initially, the user inputs information regarding the persons who can access the system and any user preferences for display of the screens, such as customizing the screen displays. The user inputs information regarding the buildings to be maintained, including basic information such as addresses and telephone numbers and more detailed information such as various locations within and around the buildings. These locations will be used to develop security guard tours, maintenance and preventative maintenance schedules, and to pinpoint incident and item reports. The user inputs information regarding the various personnel associated with the buildings such as security officers and maintenance personnel.

Once the basic information regarding the buildings and the personnel is entered into the database of the system, the user can create the property management customization. More specifically, the user can set up posts within the buildings, locations within the buildings, scheduled tasks to be completed, tours for the security officers, alerts, reports, and methods of sending alerts and reports to the appropriate person(s).

Using security as an illustrative example, using the appropriate input screen, the user can set up at least two manners for security to be effected within the buildings. A first manner is to set up security officer tours, which are tours around and through the buildings for the security officers to follow. The user selects the locations and/or posts within and around the buildings, organizes them into a coherent list, and thus creates a tour. A second manner is to set up individual incidents or items that need to be checked. These individual items or incidents can be one-time, multiple time, or recurring items or incidents that are not part of a tour. Once the tours and/or the individual items or incidents are inputted into the database, the database is updated and the information sent out to the particular security officer. For maintenance, the user can set up various actual and preventative maintenance schedules and individual tasks for the maintenance personnel to complete.

The security officers and maintenance personnel carry wireless handheld computing devices with them, such as personal digital assistants (PDAs) programmed for the system. The tour, schedule, and/or individual items or incidents are sent by the system to these PDAs, where the security officers and maintenance personnel receive them and can act on them. Thus, the security officers and maintenance personnel receive their individualized orders for the hour, day, week, month, or any other time period chosen by the managers. Once the security officers and maintenance personnel have their tours, schedules, and/or individual items or incidents, the security officers and maintenance personnel can begin their work.

As the security officer completes a tour, the security officer proceeds from location to location as called for in the tour created by the user. When the security officer arrives at a location, the security officer can check off on the PDA that he or she has been to the location. For example, the tour will show up on the PDA screen, and the security officer can check off a box or other icon for the location using touch screen or other input technology. Similarly, when the security officer arrives and investigates an individual item or incident, the security officer can check off a box when the investigation is complete. Further, the security officer can record notes or comments. As the security officer inputs this information into the PDA, the system and system database is updated in real time. The manager thus receives up to the minute information and is able to change or adapt the security officer's orders as necessary, and to contact appropriate persons such as the owner, fire, or law enforcements as necessary. Further, alerts and reports, as disclosed in more detail below, can be generated.

Similarly, when the maintenance person arrives at a location and completes scheduled maintenance, the maintenance person can check off on the PDA that he or she has been to the location and completed the specified maintenance. Likewise, when the maintenance person arrives and complete an individual maintenance item or incident, the maintenance person can check off a box. The maintenance person can record notes or comments. As the information is inputted into the PDA, the system and system database is updated in real time. The manager thus receives up to the minute information and is able to change or adapt the maintenance person's orders as necessary, and to contact appropriate persons as necessary. Further, alerts and reports, as disclosed in more detail below, can be generated.

One aspect of the tour and item/incident scheduling is that each particular location on the tour or each individual item/incident can be assigned a certain time for completion. If the location is not checked, or the item/incident is not investigated, by that assigned time, an alert can be generated to inform the security guard of the departure from the schedule and/or to alert the manager that the security guard is off schedule. This provides real time automated tracking and managing of schedules.

One aspect of the PDA to system database linkage between the security officer, maintenance personnel, or other staff and the manager's location is the ability for the security officer, maintenance personnel, or other staff to report any unscheduled items or incidents to the manager. For example, if the security officer comes across a break in or an unauthorized person or vehicle, the security officer can input this information into the PDA, the system will be updated in real time, and the manager will be notified of this item or incident. The manager then can authorize or take the appropriate action.

Back at the manager's location, manager summary screens provide information to the manager regarding the tours and any individual items or incidents. Thus, the manager has the real time progress and results of all the tours, scheduled items/incidents, and unscheduled items/incidents and can act accordingly. This feature allows the manager to be completely informed regarding the status of the building without having to compile separate manual tour or item/incident reports.

Various types of items and incidents can be pre-inputted into the system database. Each item/incident also can be assigned a level of importance. Thus, if and when an item/incident arises, the security officer, maintenance personnel, or other staff has a list of items/incidents to choose from, speeding up the reporting of such an item/incident. Further, when the item/incident is reported to the system, the system can prioritize the item/incident. This allows the manager to make certain that more important items/incidents are dealt with first. The automation of the items/incidents in this manner makes property management more efficient.

One aspect of the system is the ability to send out alerts to predetermined people or groups of people upon the occurrence of a particular event or item/incident. Specifically, the system can be preprogrammed to send out alerts upon the occurrence of a particular item/incident. An alert includes sending a message text to a mobile telephone, creating an instant message on a personal computer, creating a pop up box on a personal computer or PDA, sending a signal to a pager, making an automated telephone call, and the like. The alerts can be customized through the system to be sent to various devices and to one or more, or groups of, people. Following are several illustrative examples.

If a security officer reports a break in, an alert in the form of a text message can be sent to a supervisor's mobile phone. If a security officer or a smoke detector detects a fire, an alert in the form of a pop up screen can be sent to the manager's computer and the fire department's call center. If an earthquake destroys a building, an alert in the form of an instant message can be sent to the owner's computer. If a security officer reports a broken water pipe, an alert in the form of a page can be sent to the maintenance personnel. If a maintenance person reports a leaking, coffee pot or dishwasher, an alert can be sent to the appropriate tenant. If a maintenance person reports an unauthorized cooking oven, an alert can be sent to the property management agent.

Another aspect of the system is the ability to generate and deliver real time reports to the appropriate persons as necessary. Following are several examples. The manager of the system receives real time reports through his or her computer. These reports can include item/incident reports, tour reports, ingress/egress reports, and any other configured reports appropriate to a building. The system can be instructed to create security related reports upon occurrence and/or at set intervals and to send these reports to the head of security on his or her computer or PDA. The system can be instructed to create maintenance related on occurrence and/or at set intervals and to send these reports to the head of maintenance on his or her computer or PDA. Likewise, other similar reports can be compiled and sent to the appropriate person(s). This allows information about the building to be disseminated to the appropriate person(s) in real time and in a coherent format.

Although the above illustrative example is primarily for security and secondarily for maintenance, the invention can be applied to all property management aspects, such as security, maintenance, janitorial and grounds keeping. Further, the present invention can be used as a complete property management system for managing all of these aspects of property management and more.

5. Second Illustrative Example with Reference to the Appendix.

The appendix steps through an illustrative example of the system by following sequential screen shots of the system in operation on a computer. Each page of the Appendix will be referred to in short as APX, where “AP” is short for “Appendix” and “X” is the page number.

AP1 lists a few of the features, some of which are optional, for the system. AP2 shows a “front page” screen through which the user can view the various properties (upper left), an Executive Summary of incidences and status (upper right), and mail from staff (lower right). As can be seen, this page provides “folders” for the front page, the Control Room, Personnel, and Preferences.

AP3 illustrates the status of an example incidence. Incidences requiring action can be highlighted in some fashion. AP4 illustrates the ability to check (include) or uncheck (remove) various properties from being monitored. AP5 illustrates that incidences can be entered into the system using plain language.

AP6 gives an overview of the security officer reporting tool of the present invention. Briefly, the security officer would enter the incidence into the system. A security manager could review and amend the incidence report. The property manager could access the reports for their property. AP7 illustrates the entry of the incidence. AP8 illustrates a sample incidence entry screen that the security officer could access to enter the incidence or a checklist screen for items the security officer should address while on his or her rounds. AP9 illustrates the screen for entering information about each incidence. AP10 illustrates a drop-down menu for standard incidences that can be selected to save time. AP11 illustrates a drop-down menu for locations throughout the property that can be selected to save time. AP12 illustrates a sample incidence report. AP13 illustrates the incidence report of AP12 as sent to a security officer to investigate.

AP14 gives an overview of the manager summary function of the present invention. AP15 illustrates a screen that a manager would view when logged onto the system. The manager can see the various incidence reports, their status, whether the incidence has been handled, and to whom the incidence has been assigned.

AP16 gives an overview of the executive summary function of the present invention. AP17 illustrates a screen that provides an executive summary of the properties, security incidences, maintenance incidences, and email for a particular client, in this case a property owner. The client can view all of the pertinent incidences for the property. AP18 illustrates how an incidence can be amended from a level 1 status (urgent) to a level 2 status (under control) by the security officer or manager after the incidence has been addressed. AP19 illustrates how a client can view the details of an incidence, in this case, a level 1 (urgent) incidence.

AP20 gives an overview of the PDA synchronization function of the present invention. AP21 illustrates how the user designates whether an item should be synchronized with a PDA (or other remote device) and uploaded into the database computer. AP22 illustrates how the system automatically indicates whether synchronization has occurred. AP23 illustrates how the system compares the input by the security guard or other input person with the desired response, and notes if there are any discrepancies (that is, if the system believes the input should be “yes”, but it is “no”, there is a discrepancy). AP 24 illustrates how the discrepancies then are transmitted in the manager summary. In this fashion, a discrepancy becomes an incidence and is reported for investigation.

AP25 gives an overview of the pass-on schedule function of the present invention. In this example, the pass-on function illustrates the shift chronology or schedule for a security officer. AP26 illustrates the ability to schedule daily to do lists for employees and the like. AP27 illustrates how the employees' schedules can be actively managed by a manager by adding, deleting and/or amending scheduled tasks. AP28 illustrates the tracking of the daily tasks, and how the employee or manager can indicate within the system the estimated or desired completion time for the task, whether a task has been completed, and its urgency. AP29 illustrates how the system automatically updates the task schedule upon the input of information regarding the task. AP30 illustrates how the pass-on function can automatically notify a manager of unauthorized events, such as unauthorized or unscheduled visitors or deliveries. This can be accomplished by, for example, a receptionist entering a visit or delivery as an event, or checking off that a previously scheduled visit or delivery had occurred. AP31 illustrates the ability to download tasks and events to a PDA or other remote device.

AP32 illustrates the procedures list that has been pre-entered into the system. AP33 illustrates how the system automatically updates reports from “under control” to “urgent” if, for example, they are not completed within a target window, or if the estimated completion time is sooner than a set time period.

### Appendix

Following are 33 screen shots from an illustrative example of computer software to operate the system of the present invention. These screen shots step the reader through the steps of the system and the operation of the invention, as well as illustrate representative components, both hardware and software, for the system.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

The combination of features disclosed herein serves as the basis for a comprehensive security and property management system that is proactive rather than reactive in that it presents tasks and incidences to be rectified rather than just reports on completed tasks and incidences. Although the system has been exemplified using security and maintenance as primary features, other features can be added as deemed necessary or desired by the ultimate user.

The system of the present invention, in its best mode, is computerized. As such, it is subject to various permutations based on the programmer. The various steps and features that comprise the present invention can be placed and conducted in any suitable order without departing from the scope of the invention. Further, various individual computer programmers of ordinary skill in the field can write different computer code to carry out the various steps and features without undue experimentation. The resulting computer codes for carrying out the various steps and features fall within the scope of the present invention.

The foregoing detailed description of the preferred embodiments and the appended figure and appendices have been presented only for illustrative and descriptive purposes. They are not intended to be exhaustive and are not intended to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

What is claimed is:

1. A real property management system comprising an interactive system for reporting, tracking, and rectifying security and maintenance items and incidences in a real property site, such as a building, an office complex comprising a number of buildings, and/or a property management company having multiple buildings and multiple sites, comprising:
a. a database server for storing data information about locations in the real property site, action items concerning the real property site, and other information about the real property site;
b. client devices for inputting information to and receiving information from the database server;
c. a networked server for allowing direct client device access to the system and the database server; and
d. an interface system for allowing input to and output from the system from remote personnel at the real property site, so as to inform the system of the items and incidences and whether the items and incidences have been addressed and to inform the remote personnel of the items and incidences and the action items.

2. The system as claimed in claim 1, further comprising a network operation center for providing a means for monitoring the state of the system and clients and for checking the integrity of the system.

3. The system as claimed in claim 1, further comprising a delivery system for allowing reports to be delivered to appropriate parties through a number of different receiving media.

4. The system as claimed in claim 1, further comprising a delivery system for allowing alerts to be delivered to appropriate parties through a number of different receiving media.

5. The system as claimed in claim 1, further comprising means for proactively entering incidence information into the system and generating incidence reports for rectifying incidences.

6. The system as claimed in claim 3, wherein the delivery system for allowing reports to be delivered to appropriate parties through a number of different receiving media comprises means for customizing the reports, means for selecting the appropriate parties to whom the reports are to delivered, and means for selecting the receiving media.

7. The system as claimed in claim 6, wherein the reports are generated at set intervals based on the input to the system from the remote personnel at the real property site regarding the items and incidences and the action items.

8. The system as claimed in claim 6, wherein the reports are generated in real time based on the input to the system from the remote personnel at the real property site regarding the items and incidences and the action items.

9. The system as claimed in claim 4, wherein the delivery system for allowing alerts to be delivered to appropriate parties through a number of different receiving media comprises means for customizing the alerts, means for selecting the appropriate parties to whom the alerts are to delivered, and means for selecting the receiving media.

10. The system as claimed in claim 9, wherein the alerts are generated at set intervals based on the input to the system from the remote personnel at the real property site regarding the items and incidences and the action items.

11. The system as claimed in claim 9, wherein the alerts are generated in real time based on the input to the system from the remote personnel at the real property site regarding the items and incidences and the action items.

12. The system as claimed in claim 5, wherein the means for proactively entering incidence information into the system and generating incidence reports for rectifying incidences comprises the client devices and computer software for interpreting and categorizing the incidence information.

13. A real property management system comprising an interactive system for reporting, tracking, and rectifying security and maintenance items and incidences in a real property site, such as a building, an office complex comprising a number of buildings, and/or a property management company having multiple buildings and multiple sites, comprising:
a. a database server for storing data information about locations in the real property site, action items concerning the real property site, and other information about the real property site;
b. client devices for inputting information to and receiving information from the database server;
c. a networked server for allowing direct client device access to the system and the database server;
d. an interface system for allowing input to and output from the system from remote personnel at the real property site, so as to inform the system of the items and incidences and whether the items and incidences have been addressed and to inform the remote personnel of the items and incidences and the action items; and
e. a delivery system for allowing reports to be delivered to appropriate parties through a number of different receiving media.

14. The system as claimed in claim 13, further comprising means for proactively entering incidence information into the system and wherein the reports are incidence reports for rectifying incidences generated from the incidence information.

15. The system as claimed in claim 14, wherein the delivery system for allowing reports to be delivered to appropriate parties through a number of different receiving media comprises means for customizing the reports, means for selecting the appropriate parties to whom the reports are to delivered, and means for selecting the receiving media.

16. The system as claimed in claim 15, wherein the reports are generated at set intervals based on the input to the system from the remote personnel at the real property site regarding the items and incidences and the action items.

17. The system as claimed in claim 15, wherein the reports are generated in real time based on the input to the system from the remote personnel at the real property site regarding the items and incidences and the action items.

18. A real property management system comprising an interactive system for reporting, tracking, and rectifying security and maintenance items and incidences in a real property site, such as a building, an office complex comprising a number of buildings, and/or a property management company having multiple buildings and multiple sites, comprising:
a. a database server for storing data information about locations in the real property site, action items concerning the real property site, and other information about the real property site;
b. client devices for inputting information to and receiving information from the database server;
c. a networked server for allowing direct client device access to the system and the database server;
d. an interface system for allowing input to and output from the system from remote personnel at the real property site, so as to inform the system of the items and incidences and whether the items and incidences have been addressed and to inform the remote personnel of the items and incidences and the action items; and
e. a delivery system for allowing alerts to be delivered to appropriate parties through a number of different receiving media.

19. The system as claimed in claim 18, further comprising means for proactively entering incidence information into the system and wherein the alerts are generated from the incidence information.

20. The system as claimed in claim 19, wherein the delivery system for allowing alerts to be delivered to appropriate parties through a number of different receiving media comprises means for customizing the alerts, means for selecting the appropriate parties to whom the alerts are to delivered, and means for selecting the receiving media.

21. The system as claimed in claim 20, wherein the alerts are generated in real time based on the input to the system from the remote personnel at the real property site regarding the incidences.

22. A real property management system comprising an interactive system for reporting, tracking, and rectifying security and maintenance items and incidences in a real property site, such as a building, an office complex comprising a number of buildings, and/or a property management company having multiple buildings and multiple sites, comprising:
a. a database server for storing data information about locations in the real property site, action items concerning the real property site, and other information about the real property site;
b. client devices for inputting information to and receiving information from the database server;
c. a networked server for allowing direct client device access to the system and the database server;
d. an interface system for allowing input to and output from the system from remote personnel at the real property site, so as to inform the system of the items and incidences and whether the items and incidences have been addressed and to inform the remote personnel of the items and incidences and the action items;
e. a delivery system for allowing reports to be delivered to appropriate parties through a number of different receiving media; and
f. a delivery system for allowing alerts to be delivered to appropriate parties through a number of different receiving media.

23. The system as claimed in claim 22, further comprising means for proactively entering incidence information into the system and wherein the reports are incidence reports for rectifying incidences generated from the incidence information.

24. The system as claimed in claim 23, wherein:
a. the delivery system for allowing reports to be delivered to appropriate parties through a number of different receiving media comprises means for customizing the reports, means for selecting the appropriate parties to whom the reports are to delivered, and means for selecting the receiving media; and
b. the delivery system for allowing alerts to be delivered to appropriate parties through a number of different receiving media comprises means for customizing the alerts, means for selecting the appropriate parties to whom the alerts are to delivered, and means for selecting the receiving media.

25. The system as claimed in claim 24, wherein the reports are generated at set intervals based on the input to the system from the remote personnel at the real property site regarding the items and incidences and the action items.

26. The system as claimed in claim 24, wherein the reports are generated in real time based on the input to the system from the remote personnel at the real property site regarding the items and incidences and the action items.

27. The system as claimed in claim 24, wherein the alerts are generated in real time based on the input to the system from the remote personnel at the real property site regarding the incidences.

28. A method for managing real property via an interactive system for reporting, tracking, and rectifying security and maintenance items and incidences in a real property site, such as a building, an office complex comprising a number of buildings, and/or a property management company having multiple buildings and multiple sites, comprising the steps of:
a. inputting into a system database information regarding the persons who can access the system and information regarding the buildings to be managed;
b. creating a property management customization by setting up posts within the buildings and locations within the buildings, scheduling tasks to be completed, developing tours for personnel, and developing incidents and items;
c. creating at least one notification means selected from the group consisting of reports and alerts, and developing methods of sending reports and alerts to at least one appropriate person;
d. allowing access to the property management customization by the personnel through remote devices so as to allow the personnel to obtain work orders from the system database and to input information to the system database; and
e. providing for real time access to information in the system database and input information provided by the personnel.

29. The method as claimed in claim 28, wherein the information regarding the buildings to be managed is used to develop tours and to pinpoint incident and item reports.

30. The method as claimed in claim 28, wherein the information regarding the buildings to be managed is used to develop tours to be completed by the personnel by selecting the locations within and around the building, organizing the locations into a coherent list, and creating the tour.

31. The method as claimed in claim 30, wherein as the personnel is completing the tour, the personnel is simultaneously entering information into the system database and the system database is automatically updating itself.

32. The method as claimed in claim 28, wherein the information regarding the persons who can access the system and information regarding the buildings to be managed is used to develop individual incidents to be checked by the personnel.

33. The method as claimed in claim 32, wherein as the personnel is checking the individual incidents, the personnel is simultaneously entering information into the system database and the system database is automatically updating itself.

34. The method as claimed in claim 33, wherein the individual incidents are selected from the group consisting of one-time incidents, multiple time incidents, recurring incidents, and incidents that are not part of a tour.

35. The method as claimed in claim 28, wherein personnel input information into the system database and receive information from the system database via wireless handheld computing devices.

36. The method as claimed in claim 28, wherein the incidents are pre-inputted into the system database.

37. The method as claimed in claim 36, wherein the incidents are assigned a level of importance.

38. The method as claimed in claim 37, wherein the incidents are prioritize in order of importance.

39. The method as claimed in claim 28, further comprising the step of sending out an alert to a predetermined person upon the occurrence of a particular event.

40. The method as claimed in claim 39, wherein the alert is sent in the form of the group consisting of sending a message text to a mobile telephone, creating an instant message on a personal computer, creating a pop up box on a personal computer or PDA, sending a signal to a pager, and making an automated telephone call.

41. The method as claimed in claim 28, further comprising the step of generating real time reports regarding the tours and the incidents.

42. The method as claimed in claim 41, wherein the reports are delivered to an appropriate person.

43. The method as claimed in claim 42, wherein the report is sent in the form of the group consisting of sending a message text to a mobile telephone, creating an instant message on a personal computer, creating a pop up box on a personal computer or PDA, sending a signal to a pager, and making an automated telephone call.

44. A method for managing real property via an interactive system for reporting, tracking, and rectifying security and maintenance items and incidences in a real property site, such as a building, an office complex comprising a number of buildings, and/or a property management company having multiple buildings and multiple sites, comprising the steps of:
a. inputting into a system database information regarding the persons who can access the system and information regarding the buildings to be managed;
b. creating a property management customization by setting up posts within the buildings and locations within the buildings, scheduling tasks to be completed, developing tours for personnel, and developing incidents and items;
c. creating at least one notification means selected from the group consisting of reports and alerts, and developing methods of sending reports and alerts to at least one appropriate person;
d. allowing access to the property management customization by the personnel through remote devices so as to allow the personnel to obtain work orders from the system database and to input information to the system database;
e. providing for real time access to information in the system database and input information provided by the personnel; and
f. generating real time reports regarding the tours and the incidents.

45. The method as claimed in claim 44, wherein the information regarding the buildings to be managed is used to develop tours and to pinpoint incident and item reports.

46. The method as claimed in claim 45, wherein the information regarding the buildings to be managed is used to develop tours to be completed by the personnel by selecting the locations within and around the building, organizing the locations into a coherent list, and creating the tour.

47. The method as claimed in claim 46, wherein as the personnel is completing the tour, the personnel is simultaneously entering information into the system database and the system database is automatically updating itself.

48. The method as claimed in claim 44, wherein the information regarding the persons who can access the system and information regarding the buildings to be managed is used to develop individual incidents to be checked by the personnel.

49. The method as claimed in claim 48, wherein as the personnel is checking the individual incidents, the personnel is simultaneously entering information into the system database and the system database is automatically updating itself.

50. The method as claimed in claim 49, wherein the individual incidents are selected from the group consisting of one-time incidents, multiple time incidents, recurring incidents, and incidents that are not part of a tour.

51. The method as claimed in claim 28, wherein personnel input information into the system database and receive information from the system database via wireless handheld computing devices.

52. The method as claimed in claim 44, wherein the incidents are pre-inputted into the system database.

53. The method as claimed in claim 52, wherein the incidents are assigned a level of importance.

54. The method as claimed in claim 53, wherein the incidents are prioritize in order of importance.

55. The method as claimed in claim 44, further comprising the step of sending out an alert to a predetermined person upon the occurrence of a particular event.

56. The method as claimed in claim 55, wherein the alert is sent in the form of the group consisting of sending a message text to a mobile telephone, creating an instant message on a personal computer, creating a pop up box on a personal computer or PDA, sending a signal to a pager, and making an automated telephone call.

57. The method as claimed in claim 44, wherein the reports are delivered to an appropriate person.

58. The method as claimed in claim 57, wherein the report is sent in the form of the group consisting of sending a message text to a mobile telephone, creating an instant message on a personal computer, creating a pop up box on a personal computer or PDA, sending a signal to a pager, and making an automated telephone call.
